(19) United States
(12) Patent Application Publication
(10) Pub. No.: US 2005/0195205 A1
(43) Pub. Date: Sep. 8, 2005

(54) Method and apparatus to decode a streaming file directly to display drivers

(75) Inventor: Thomas Algie Abrams JR., Snowhomish, WA (US)

Correspondence Address: LEYDIG, VOIT & MAYER, LTD., TWO PRUDENTIAL PLAZA, SUITE 4900, 180 NORTH STETSON, CHICAGO, IL, 60601-6780, US

(73) Assignee: Microsoft Corporation, Redmond, WA (US)

(21) Appl. No.: 10/792,338

(22) Filed: Mar. 3, 2004

(51) Int. Cl. G09G 5/36

(52) U.S. Cl. 345/545

(57) ABSTRACT

A method and apparatus is presented for decoding an encoded streaming media file and outputting the decoded streaming media file directly in the frame buffer of a driver, thereby eliminating the need for intermediate buffers for audio, video, and print devices. The method provides the capability to capture audio, video, and/or print (and metadata) at a point and apply digital rights management to the data from the point of capture to the point of rendering. The invention works with any rendering technology that uses frame buffers, such as digital light processing (DLP) device, liquid crystal displays (LCDs), and MEM (Micro-electro-mechanical) imaging devices.

### FIELD OF THE INVENTION

This invention relates to file streaming decoding and, more particularly, relates to file streaming decoding.

### BACKGROUND OF THE INVENTION

Almost all media data is derived from signal based sources, via signal based systems that are analog in nature. Most modern media systems can be thought of as islands of processing (e.g., isolated processing centers) connected by a real-time signal-based infrastructure. All of these systems are based on a signal infrastructure, where increased energy levels produce corresponding deviations from a native state. For film, the deviations are based on levels of exposure. For video, it is a 0.7 volt sliding scale based on light intensity. For audio, it's an undulating voltage based on instantaneous sound pressure levels. These are expressed as raw analog voltages or as digital replicas of that voltage.

The first digitization of media systems occurred at the device layer and then was later applied systemically. However, though these systems were digitized, they still maintain the original “analog” point-to-point form for the signal layer between digital processing centers. These are defined as AES, SMPTE 259M, SMPTE 292, etc.

These island processes, such as capture, storage, encoding, transport, and decoding, etc, treat their ingested multimedia (i.e., audio and video) data similarly. For example, a substantial portion of present day video is captured by video cameras that utilize charge-coupled device (CCD) imagers to capture the light energy (e.g., intensity, color, etc.). The “energy” of CCD imager is stored in the camera as a bit mapped image and digitized to 8 bits or 256 levels, and then converted to a standardized video output. The video output is stored to tape or disc. A streaming video encoder, such as a WMF (Windows Metafile Format) encoder, receives this video output and derives a 256 level bit mapped frame before encoding the signal into a file (e.g., DVD, streaming files, digital tape, etc.) conforming to the transport being used for transmission (e.g., broadcast, physical media, virtual media, “sneakernet”, etc.). The decoder takes the file, converts it into a standardized video signal output and sends it to a display driver. The display driver, in turn, decodes the signal into a bitmap, such as an RGB bitmap, which is then sent to a monitor for display. A similar process occurs when a CMY (or CMYK) bitmap is used.

It can be seen from the above example that current processing techniques involves capturing, storing, translating, and routing of the data that typically require numerous compressions, bandwidth reductions, and/or signal translations in order to fit the data into various storage or transport implementations. The possibility exists that the data can be stolen at any point in the processing chain.

For example, prior to the encoding stage, the raw data is available to anyone who has access. This is a problem in the movie industry as personnel processing the daily shoots have full access to the raw data because it has not been encoded to apply digital rights management (DRM) techniques to secure the data. A similar problem can occur in the recording industry. At each capture, storage, translation, and routing event, a possibility exists that the data can be tampered with or be stolen.

### BRIEF SUMMARY OF THE INVENTION

The invention provides a decoder that is designed to take an encoded multimedia file, and, instead of converting the file to a video and audio signal (or intermediate print signal), converts it directly to the format of the driver frame buffer used for rendering (e.g., RGB color elements, CMY color elements, etc.), thereby eliminating the intermediate processing and storage steps and providing greater secure control of the decompression process. By eliminating the intermediate steps, the data can be protected with digital rights management and other security techniques up to the instant it is being rendered.

The rendering devices that may be used with the invention include devices incorporating digital light processing (DLP) technology for projectors used in theaters and home entertainment and flat panel displays; liquid crystal displays (LCDs) for monitors, notebook computers, and other flat panel displays; and MEM (Micro-Electro Mechanical) devices such as copiers and fax machines.

Additional features and advantages of the invention will be made apparent from the following detailed description of illustrative embodiments which proceeds with reference to the accompanying figures.

### BRIEF DESCRIPTION OF THE DRAWINGS

While the appended claims set forth the features of the present invention with particularity, the invention, together with its objects and advantages, may be best understood from the following detailed description taken in conjunction with the accompanying drawings of which:

FIG. 1 is a client/network system in accordance with exemplary embodiments;

FIG. 2 is a block diagram generally illustrating an exemplary processing network environment in which the present invention can be used;

FIG. 3 is a display decoder in accordance with an exemplary embodiment; and

FIG. 4 is a flowchart of an exemplary embodiment of processing for file stream decoding and display.

### DETAILED DESCRIPTION OF THE INVENTION

Conventional decoder systems go through the steps of receiving a file from IP transport, storing the file in temporal data storage, deriving Macro Blocks, applying motion vectors, deriving a bitmapped frame representation of the data, converting the bitmapped frame representation into a video output and sending it to the display driver where the display driver converts the video output into a bitmapped frame buffer for outputting a signal into RGB for display (or CMY for printing). Unlike conventional systems, the present invention takes a signal input, decompresses and/or decrypts it and injects it directly into a bitmapped frame buffer (thereby bypassing local storage drives and/or devices) where it is then output into a format ranging from pixel based luminance (e.g., RGB, CMY, CMYK) to PWM (Pulse Width Modulation) for driving a mirror (e.g., DLP [Digital Light Processing] display), MEM (Micro-Electro Mechanical) element, or LCD (Liquid Crystal Display) element. The decoder of the present invention receives an encoded multimedia file and converts it directly to the format the display driver requires for display (e.g., RGB color elements, pulse width modulation commands, etc.), thereby eliminating intermediate translation steps and providing digital rights management (DRM) protection to the data. By eliminating the intermediate steps, the data is protectable with DRM up to the instant it is being displayed.

Turning to the drawings, wherein like reference numerals refer to like elements, the invention is illustrated as being implemented in a suitable computing environment. Although not required, the invention will be described in the general context of computer-executable instructions, such as program modules, being executed by a personal computer. Generally, program modules include routines, programs, objects, components, data structures, etc. that perform particular tasks or implement particular abstract data types. Moreover, those skilled in the art will appreciate that the invention may be practiced with other computer system configurations, including hand-held devices, multi-processor systems, microprocessor based or programmable consumer electronics, network PCs, minicomputers, mainframe computers, and the like. The invention may also be practiced in distributed computing environments where tasks are performed by remote processing devices that are linked through a communications network. In a distributed computing environment, program modules may be located in both local and remote memory storage devices.

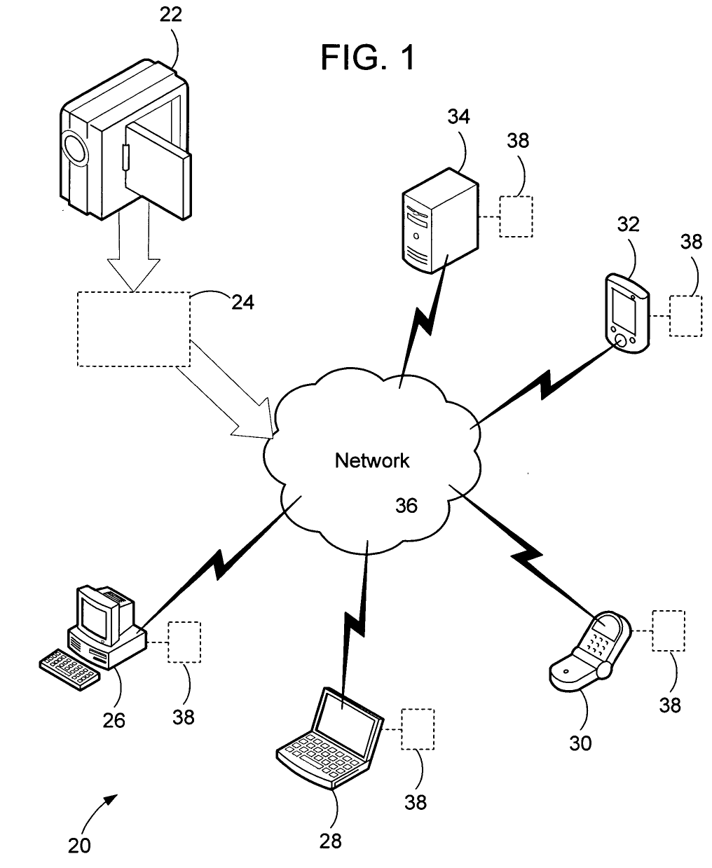

In the example client/network system 20 of FIG. 1, imaging device 22 in conjunction with encoder 24 is capable of streaming image data files to any one of client computing devices 26, 28, 30, and 32, which are also referred to as clients, as well as to server device 34 via network 36. Network 36 represents any of a variety of conventional network topologies and types, which may include wired and/or wireless networks. Network 36 may further utilize any of a variety of conventional network protocols, including public and/or proprietary protocols. Network 36 may include, for example, the Internet as well as possibly at least portions of one or more local area networks (LANs) or wide area networks (WANs). Network 36 may also be a private intranet or a home network.

Imaging device 22 may be a camcorder or VTR (video tape recorder) that is capable of capturing analog or digital video image data. Examples of imaging device 22 include, but are not limited to, personal camcorders, security monitoring cameras, webcams, and television broadcasting cameras. Encoder 24 may be separate from imaging device 22 or it may be integrated with imaging device 22 as described in U.S. patent application Ser. No. 10/740,147, filed on Dec. 17, 2003 and entitled “Managing File Stream Generation”, assigned to the same assignee and hereby incorporated by reference in its entirety.

Computing device 26 may include any of a variety of conventional computing devices, including a desktop personal computer (PC), workstations, mainframe computers, Internet appliances, and gaming consoles. Further computing devices associated with network 36 may include a laptop computer 28, cellular telephone 30, personal digital assistant (PDA) 32, etc., all of which may communicate with network 36 by a wired and/or wireless link. Further still, one or more of computing devices 26, 28, 30 and 32 may include the same types of devices, or alternatively different types of devices. Server device 34, which may be a network server, an application server, or a combination thereof, may provide any of a variety of data and/or functionality to computing devices 26, 28, 30, 32 as well as to imaging device 22 and encoder 24. The data may be publicly available or alternatively restricted (e.g., restricted to only certain users, available only if the appropriate fee is paid, etc.). Each of the computing devices 26, 28, 30, 32 and server device 34 have a decoder 38 that receives an encoded file from encoder 24 and converts the encoded file directly into the bitmapped frame buffer of the display driver for display on the computing device. The display driver may be for DLP, (Digital Light Processing) devices, MEM (Micro Electro-Mechanical) devices, and LCD (Liquid Crystal Display) devices such as flat panel displays, projectors, copiers, fax machines, and the like.

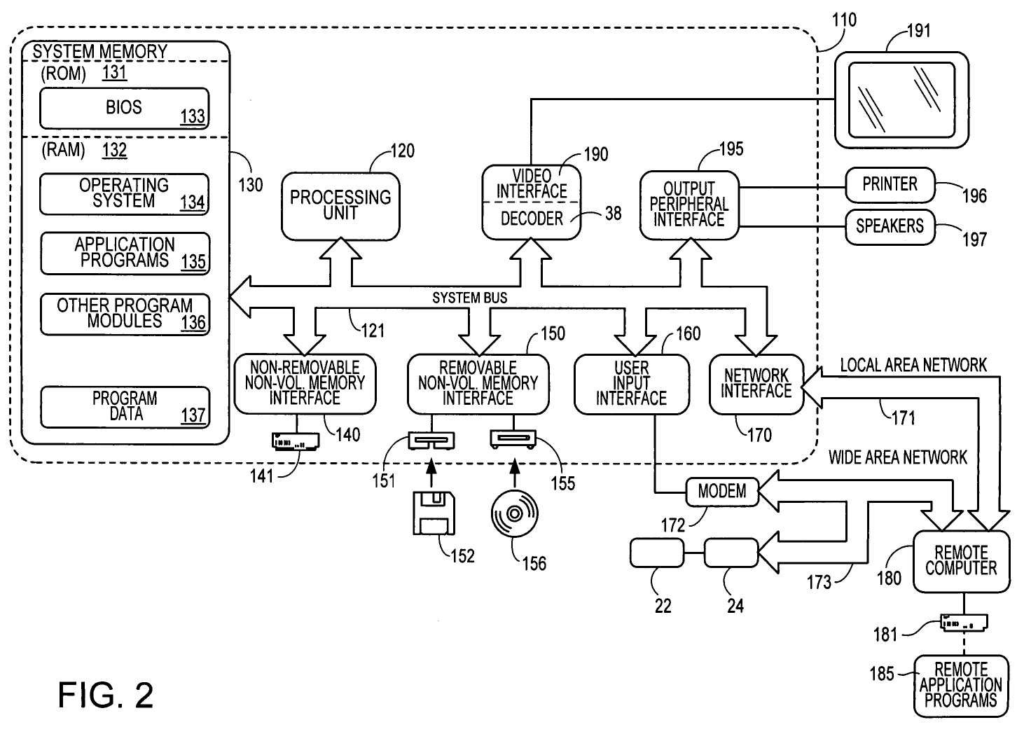

FIG. 2 illustrates an example of a suitable processing environment 100 on which the invention may be implemented. The processing environment 100 is only one example of a suitable computing environment and is not intended to suggest any limitation as to the scope of use or functionality of the invention. Neither should the processing environment 100 be interpreted as having any dependency or requirement relating to any one or combination of components illustrated in the exemplary environment 100.

The invention is operational with numerous other general purpose or special purpose computing system environments or configurations. Examples of well known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 2, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, and removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application (e.g., DRM) programs 135, other program modules 136, and program data 137.

The computer 110 may also include other removable/non-removable, volatile/nonvolatile computer storage media. By way of example only, FIG. 2 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media, discussed above and illustrated in FIG. 2, provide storage of computer readable instructions, data structures, program modules and other data for the computer 110. A user may enter commands and information into the computer 110 through input devices such as a keyboard, a pointing device, commonly referred to as a mouse, trackball or touch pad, a microphone, and a tablet or electronic digitizer. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. The monitor 191 may also be integrated with a touch-screen panel or the like. Note that the monitor and/or touch screen panel can be physically coupled to a housing in which the computing device 110 is incorporated, such as in a tablet-type personal computer. In addition, computers such as the computing device 110 may also include other peripheral output devices such as speakers 197 and printer 196, which may be connected through an output peripheral interface 194 or the like.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 2. The logical connections depicted in FIG. 2 include a local area network (LAN) 171 a wide area network (WAN) 173 such as the Internet, and but may also include other networks. Such networking environments are commonplace in offices, enterprise-wide computer networks, intranets and the Internet. For example, the computer system 110 may comprise the source machine from which data is being migrated, and the remote computer 180 may comprise the destination machine. Note however that source and destination machines need not be connected by a network or any other means, but instead, data may be migrated via any media capable of being written by the source platform and read by the destination platform or platforms.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 2 illustrates remote application programs 185 as residing on memory device 181. It will be appreciated that the network connections shown are exemplary and other means of establishing a communications link between the computers may be used. FIG. 2 illustrates encoder 24 and imaging device 22 connected to the computer 110 via WAN 173.

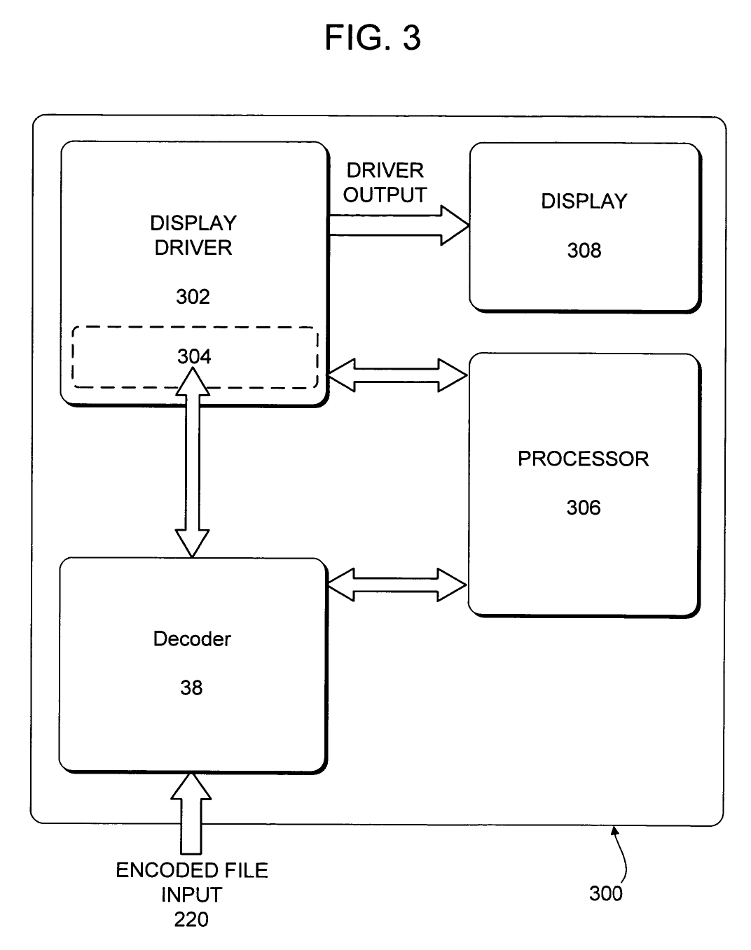

In the description that follows, decoder 38 will be described as being integral with a display driver in a display device 300 having display 308. It will be appreciated that the decoder 38 may be integrated with other display drivers in other types of systems such as audio systems, print systems, and the like. FIG. 3 shows an example embodiment of display device 300. Display device 300 includes display driver 302 having a bitmapped frame buffer 304, decoder 38, processor 306, and display 308. Furthermore, display driver 302, decoder 38, and processor 306 are incorporated within a single module, on a single substrate or integrated circuit (IC). Alternatively, display driver 300, decoder 38, and processor 306 are disposed on substrates or ICs, either singularly or in various combinations thereof, that are adjacent to each other within display device 300. In systems such as computer system 110, the display driver 300 and decoder 38 may be adjacent to each other and processing unit 120 may be used for processing.

Decoder 38 is a media file decoder for executing a decoding algorithm to acquire full bandwidth rendering for an encoded video image file to be decoded and be directly injected into the bitmapped frame buffer 304 of display driver 302 for display on display 308. The decoding algorithm may decompress the captured image data from, e.g., a Windows Media File (WMF), QuickTime® file, and MPEG-2 file, or a next-generation MPEG file and write the output directly to the bitmapped frame buffer 304 that the display driver 302 uses to create an image on the display 308. A non-limiting example of such full bandwidth rendering includes decoding a streaming file in which encoder 24 has performed RGB to YUV conversion for assembly as a 4:4:4, 4:2:2, 4:1:1, 4:2:0, or 8:8:8 streaming file with real-time metadata and DRM wrapped around the streaming file, wherein Y, U, and V are samples packed together in macropixels, known in the art as a “macro-block,” and stored in a single array. The “A:B:C” notation for YUV describes how often U and V are sampled relative to Y.

The processor 306 receives metadata information from decoder 38 to change display features of display 308. For example, processor 306 may change the video refresh rate of display 308 based upon the metadata in the stream. Processor 306 may also add close captioning to the display 308 upon receiving metadata indicating that close captioning should be provided. Further, the metadata may include resolution requirements and the processor 306 changes resolution of the display 308.

During operation, the decoder 38 receives encoded files and decodes the files as is known in the art. The decoder 38 and/or processor 306 are able to unwrap any DRM applied to the files if the user has proper authority. As used herein, unwrapping DRM means reversing the DRM applied to the files. DRM, as is known in the art, is a set of technologies that content owners can use to protect their copyrighted materials, such as the media files produced by imaging device 22. DRM is implemented as an application to encrypt digital media content to thereby limit access to only those parties having acquired a proper license to download the media file content. As an alternative, “watermarks” enable encoder 24 to add proprietary information, such as a copyright or artist's name, to an audio and/or video file stream without being audible or visible to an end user. A watermark is preserved in the encoded file if the file is copied or encoded again, and therefore can be read from the file to verify the source and/or authenticity of the file. Yet another alternative is trusted hardware as that term is used in the area of DRM technology. Further details of DRM technology are not necessary for implementation of the present example, other than that decoder 38 and/or processor 306 may “unwrap,” a particular DRM application on a media file encoded by encoder 24.

If the imaging device 22 and encoder 24 are integrated, then DRM can be applied to content from photon capture (by the imaging device 22) to photon display on display 308. Such a system allows a secure pathway from video capture to video display with no analog video signal anywhere in the pathway, thereby making a very secure pathway. Information within the encoded file such as metadata can be used to control features or functions of the computing device 26, 28, 30, 32, and 34 such as refresh rate, display resolution, screen size, volume, surround sound settings, etc.

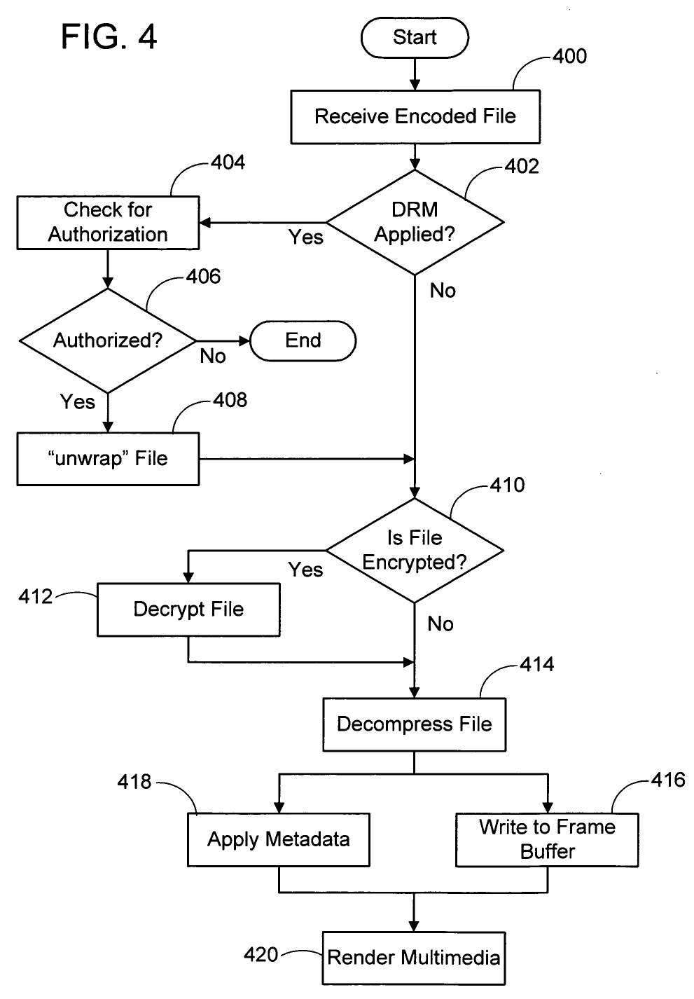

FIG. 4 illustrates an exemplary embodiment of the processing implemented by display device 300 of FIG. 3. The decoder 38 receives the encoded file (step 400). The device 300 (e.g., decoder 38 and/or processor 306) determines if DRM has been applied (step 402). If DRM has been applied, the device 300 checks to determine if the user has authorization to receive and view the file (step 404). This may be done via checking a registry, asking the user for a password, etc. If the user does not have authorization, the display device 300 does no further processing on the file. If the user does have authorization, the file is “unwrapped” (step 408) and the decoder 38 proceeds with processing the file.

The system also determines if the file has been encrypted (step 410). The file is decrypted if the user has authorization (step 412). After decryption or if there is no decryption, the encoded file is decompressed (step 414). The decoder 38 decompresses the multimedia data directly into the frame buffer 304 of the display driver 302 (step 416). In one embodiment, the decoder 38 transforms the multimedia data into the format required by the display driver 302. For example, the multimedia data is transformed into pixel-based luminance (e.g., RGB) for conventional display types. For DLP devices, the multimedia data is transformed into pulse width modulated signals to drive mirrors in the display. Metadata embedded within the data is applied by the processor 306 in conjunction with display driver 302 (step 418) as the display driver 302 renders the multimedia on display 308 from the frame buffer 304 (step 420).

The invention may be implemented in various types of display devices. In addition to the computing devices previously described, the invention may be implemented in any display device that uses a bitmapped display. By way of illustration and not limitation, such devices include DLP (Digital Light Processing) devices, MEM (Micro Electro-Mechanical) devices, and LCD (Liquid Crystal Display) devices such as flat panel displays, television sets, projectors, copiers, fax machines, etc. These devices can be used to allow movie executives to stream daily releases of movies and be confident only authorized users can see them.

As can be seen from the foregoing, the present invention provides a method and apparatus that does not require intermediate signal conversions of multimedia files. As such, the need for intermediate storage buffers is eliminated for audio, video, and print mediums. If the decoder is built onto the same silicon substrate (or other integrated substrate such as GaAs and the like) as the display driver, a pathway is provided for DRM application up to “photon emission” in that only authorized users can see or hear the multimedia file.

All of the references cited herein, including patents, patent applications, and publications, are hereby incorporated in their entireties by reference.

In view of the many possible embodiments to which the principles of this invention may be applied, it should be recognized that the embodiment described herein with respect to the drawing figures is meant to be illustrative only and should not be taken as limiting the scope of invention. For example, those of skill in the art will recognize that the elements of the illustrated embodiment shown in software may be implemented in hardware and vice versa or that the illustrated embodiment can be modified in arrangement and detail without departing from the spirit of the invention. Therefore, the invention as described herein contemplates all such embodiments as may come within the scope of the following claims and equivalents thereof.

1. A display driver to display a file stream, comprising:
a display driver module having a bitmapped frame buffer, the display driver module controlling the display; and
a decoder to transform the file stream and store the transformed file stream in the bitmapped frame buffer of the display driver module, the display driver adapted to process data in the bitmapped frame buffer to generate the display.

2. The display driver of claim 1 wherein the display driver module and decoder are disposed on a same substrate.

3. The display driver of claim 1 wherein the display driver is adapted to perform the steps comprising:
determining if a user has authorization if digital rights management has been applied to the file stream; and
if the user has authorization, performing the steps of transforming the file stream and storing the transformed file stream in the bitmapped frame buffer.

4. The display driver of claim 3 wherein the display driver is further adapted to perform the step of decrypting the file stream if the file stream is encrypted.

5. The display driver of claim 1 wherein the file stream contains metadata, the display driver further comprising a processor to process metadata from the file stream.

6. The display driver of claim 1 wherein decoder is adapted to transform the file stream from a MPEG-2 format into the bitmapped frame buffer of the display driver module.

7. The display driver of claim 1 wherein decoder is adapted to transform the file stream from a Windows Media File (WMF) format into the bitmapped frame buffer of the display driver module.

8. The display driver of claim 1 wherein decoder is adapted to transform the file stream from a next generation MPEG compression scheme format into the bitmapped frame buffer of the display driver module.

9. The display driver of claim 1 wherein the display driver is adapted to process data in the bitmapped frame buffer to generate a Digital Light Processing display.

10. The display driver of claim 1 wherein the display driver is adapted to process data in the bitmapped frame buffer to generate a Liquid Crystal Device (LCD) display.

11. The display driver of claim 1 wherein the display driver is adapted to process data in the bitmapped frame buffer to generate a command signal to drive a Micro Electrical Mechanical (MEM) controlled rendering device.

12. A method to drive a display driver of an encoded file stream comprising the steps of:
receiving the encoded file stream;
transforming the encoded file stream into a format of the display driver, thereby generating a transformed file stream; and
storing the transformed file stream in the bitmapped frame buffer of the display driver.

13. The method of claim 12 further comprising the step of decoding the encoded file stream.

14. The method of claim 12 further comprising the step of processing data in the bitmapped frame buffer to generate a display.

15. The method of claim 14 wherein the step of processing data in the bitmapped frame buffer to generate a display comprises the step of processing data in the bitmapped frame buffer to generate a Digital Light Processing display.

16. The method of claim 14 wherein the step of processing data in the bitmapped frame buffer to generate a display comprises the step of processing data in the bitmapped frame buffer to generate a Liquid Crystal Device (LCD) display.

17. The method of claim 12 wherein the step of processing data in the bitmapped frame buffer to generate a display comprises the step of processing data in the bitmapped frame buffer to generate a command signal to drive a Micro Electrical Mechanical (MEM) controlled device.

18. The method of claim 12 wherein steps are performed on a same substrate.

19. The method of claim 12 further comprising the steps of:
determining if a user has authorization if digital rights management has been applied to the file stream;
if the user has authorization, performing the steps of transforming the file stream into a format of the display driver module and storing the transformed file stream in the bitmapped frame buffer; and
dropping the file stream without performing the steps of transforming the file stream into a format of the display driver module and storing the transformed file stream in the bitmapped frame buffer if the user does not have authorization

20. The method of claim 19 further comprising the step of decrypting the file stream if the file stream is encrypted.

21. The method of claim 12 wherein the file stream contains metadata, the method further comprising the step of processing the metadata.

22. The method of claim 12 wherein the step of transforming the encoded file stream into a format of the display driver module comprises the step of transforming a MPEG-2 encoded file stream into the bitmapped frame buffer of the display driver module.

23. The method of claim 12 wherein the step of transforming the encoded file stream into a format of the display driver module comprises the step of transforming a Windows Media File (WMF) encoded file stream into the bitmapped frame buffer of the display driver module.

24. The method of claim 12 wherein the step of transforming the encoded file stream into a format of the display driver module comprises the step of transforming a next generation MPEG compression scheme encoded file stream into the bitmapped frame buffer of the display driver module.

25. A method to apply digital rights management of data from the point of capture to the point of rendering comprising the steps of:
capturing the data;
storing the data directly into a frame buffer of an encoder;
transforming the data in the frame buffer into an encoded media file;
applying digital rights management to the encoded media file;
transmitting the encoded media file to a rendering device;
unwrapping the digital rights management applied to the encoded media file;
decoding the encoded media file into a driver frame buffer; and
generating commands to control display components using data in the driver frame buffer.

26. The method of claim 25 further comprising the step of sending the commands to the rendering components.

27. The method of claim 25 wherein the steps of capturing data, storing the data directly into a frame buffer of an encoder, transforming the data in the frame buffer into an encoded media file, and applying digital rights management to the encoded media file includes performing the steps of capturing data, storing the data directly into a frame buffer of an encoder, transforming the data in the frame buffer into an encoded media file, and applying digital rights management to the encoded media file on a same substrate.

28. The method of claim 27 wherein the steps of unwrapping the digital rights management applied to the encoded media file, decoding the encoded media file into a display driver frame buffer, generating commands to control display components based on data in the driver frame buffer, and sending the commands to the display components includes performing the steps of unwrapping the digital rights management applied to the encoded media file, decoding the encoded media file into a driver frame buffer, generating commands to control display components based on data in the driver frame buffer, and sending the commands to the display components on a second substrate.

29. The method of claim 25 wherein the steps of unwrapping the digital rights management applied to the encoded media file, decoding the encoded media file into the display driver frame buffer, generating commands to control dipslay components based on data in the driver frame buffer, and sending the commands to the display components includes performing the steps of unwrapping the digital rights management applied to the encoded media file, decoding the encoded media file into the driver frame buffer, generating commands to control display components based on data in the driver frame buffer, and sending the commands to the display components on a same substrate.

30. The method of claim 25 wherein the step of transforming the data in the frame buffer into an encoded media file comprises transforming the data in the frame buffer into a MPEG-2 encoded media file and the step of decoding the encoded media file into the driver frame buffer comprises the step of decoding the MPEG-2 encoded media file into the driver frame buffer.

31. The method of claim 25 wherein the step of transforming the data in the frame buffer into an encoded media file comprises transforming the data in the frame buffer into a Windows Media File (WMF) encoded media file and the step of decoding the encoded media file into the driver frame buffer comprises the step of decoding the WMF encoded media file into the driver frame buffer.

32. The method of claim 25 wherein the step of transforming the image data in the frame buffer into an encoded media file comprises transforming the image data in the frame buffer into a next generation MPEG compression scheme encoded media file and the step of decoding the encoded media file into the driver frame buffer comprises the step of decoding the next generation MPEG compression scheme encoded media file into the driver frame buffer.

33. The method of claim 25 further comprising the step of applying metadata contained in the encoded media file.

34. The method of claim 25 wherein the step of generating commands to control display components comprises the step of generating commands to control Digital Light Processing (DLP) components.

35. The method of claim 25 wherein the step of generating commands to control display components comprises the step of generating commands to control Liquid Crystal Device (LCD) components.

36. The method of claim 25 wherein the step of generating commands to control display components comprises the step of generating commands to control a Micro Electrical Mechanical (MEM) controlled device.
